(19) United States
(12) Patent Application Publication
(10) Pub. No.: US 2010/0155992 A1
(43) Pub. Date: Jun. 24, 2010

(54) MOLD RESIN MOLDING METHOD AND MOLD RESIN MOLDING APPARATUS

(75) Inventors: Nobuyuki Kurashima, Nagano-shi (JP); Toshio Kobayashi, Nagano-shi (JP)

Correspondence Address: RANKIN, HILL & CLARK LLP, 38210 Glenn Avenue, WILLOUGHBY, OH, 44094-7808, US

(73) Assignee: SHINKO ELECTRIC INDUSTRIES CO., LTD., Nagano-shi (JP)

(21) Appl. No.: 12/644,399

(22) Filed: Dec. 22, 2009

(30) Foreign Application Priority Data
Dec. 24, 2008 (JP) 2008-328356

(51) Int. Cl. B29C 45/14

(52) U.S. Cl. 264/272.14

(57) ABSTRACT

A mold resin molding method is provided with: providing a semiconductor device including a first wiring board and a second wiring board electrically connected to the first wiring board through a solder ball; providing a metal mold including a die plate which is independently provided to enable an approach/separation to/from the second wiring board; inserting the semiconductor device into a cavity of the metal mold; abutting the die plate on a surface side of the second wiring board through a release film; injecting a mold resin in a void between the first wiring board and the second wiring board while applying a first pressure from the die plate to the second wiring board; and further injecting the mold resin in the void while applying a second pressure which is higher than the first pressure from the die plate to the second wiring board.

This application claims priority from Japanese Patent Application No. 2008-328356, filed on Dec. 24, 2008, the entire contents of which are hereby incorporated by reference.

### FIELD OF THE INVENTION

The present invention relates to a molding method and a molding apparatus, and more particularly to a mold resin molding method and a mold resin molding apparatus for a semiconductor device.

### DESCRIPTION OF RELATED ART

Japanese Patent Application Publication No. JP-A-2008-10885 discloses a related-art semiconductor device shown in FIG. 6. In the related-art semiconductor device, an underfill agent 14 is filled between a mounting surface of a first wiring board 10 and a semiconductor element 12 mounted on the mounting surface, and a second wiring board 16 is electrically connected and laminated onto the mounting surface of the first wiring board 10 through solder balls 18 and 18 in which a core part is formed of copper. Pad surfaces of pads 20 and 20 to which an external connecting terminal is attached are exposed to surfaces of the first wiring board 10 and the second wiring board 16.

Furthermore, a mold resin 22 is filled in a space between the first wiring board 10 and the second wiring board 16.

In a process for manufacturing the related-art semiconductor device shown in FIG. 6, when the mold resin 22 is to be filled in the space between the first wiring board 10 and the second wiring board 16, the semiconductor device in which the first wiring board 10 having the semiconductor element 12 mounted thereon and the second wiring board 16 are electrically connected and laminated through the solder balls 18 and 18 as shown in FIG. 7 is inserted into a cavity of a metal mold to carry out molding.

FIG. 8 shows a metal mold to be used in the molding of the related-art semiconductor device. In a semiconductor device inserted in a cavity 100 of the metal mold shown in FIG. 8, the semiconductor element 12 is mounted on each of portions of a substrate 11 into which a plurality of first wiring boards 10 is fabricated (for example, a strap-shaped multi-cavity substrate) corresponding to each of the first wiring boards 10, and furthermore, the second wiring board 16 is electrically connected and laminated through the solder balls 18 and 18.

Referring to the metal mold shown in FIG. 8, in the substrate 11 inserted in the cavity 100 and having the second wiring boards 16 and 16 mounted thereon, a mounting surface on which the semiconductor elements 12 and 12 are mounted forms a bottom face of the cavity 100, and a die plate 104 abutting on a surface side of the second wiring boards 16 and 16 through a release film 102 is independently provided to enable an approach/separation to/from the second wiring boards 16 and 16.

Furthermore, the die plate 104 is caused to elastically abut on the second wiring boards 16 and 16 by means of springs 106 and 106 in order to apply a predetermined pressure to the second wiring boards 16 and 16 during molding.

By injecting a mold resin from a gate 108 into the cavity 100 of the metal mold, it is possible to inject the mold resin into a space between the substrate 11 and each of the second wiring boards 16 and 16.

The mold resin is injected into the space between the substrate 11 and each of the second wiring boards 16 and 16 which are inserted into the cavity 100 of the metal mold shown in FIG. 8 and the mold resin thus injected is then cooled. Thus, it is possible to obtain a molded product shown in FIG. 9.

In the molded product shown in FIG. 9, the mold resin 22 is filled in the space between the substrate 11 and each of the second wiring boards 16 and 16. Referring to the molded product, it is possible to obtain the related-art semiconductor device illustrated in FIG. 6 by carrying out cutting in a portion shown in a dotted line of FIG. 9.

However, it was known that a certain pressure is very hard to regulate when the certain pressure is applied to the second wiring boards 16 and 16 through the molding as shown in FIG. 8.

In other words, the following was found. In the case in which a pressure to be applied to the die plate is excessively low, the mold resin can easily be filled in each of the spaces between the substrate 11 and the second wiring boards 16 and 16. However, an interval between the substrate 11 and each of the second wiring boards 16 and 16 is excessively enlarged by the pressure of the mold resin filled in the space so that the solder ball 18 is apt to be disconnected.

On the other hand, in the case in which the pressure to be applied to the die plate is excessively high, the interval between the substrate 11 and each of the second wiring boards 16 and 16 is not enlarged so that the solder ball 18 can be prevented from being disconnected. However, the interval between the substrate 11 and each of the second wiring boards 16 and 16 is reduced so that the mold resin cannot be uniformly filled in the space portion between the substrate 11 and each of the second wiring boards 16 and 16 and an unfilled part of the space or a swell of the substrate is apt to occur.

### SUMMARY OF INVENTION

Illustrative aspects of the present invention provide a mold resin molding method and a mold resin molding apparatus which can fill a mold resin easily and uniformly while maintaining a connection of a solder ball in a space between a first wiring board and a second wiring board.

According to a first aspect of the invention, a mold resin molding method is provided with: providing a semiconductor device including a first wiring board and a second wiring board electrically connected to the first wiring board through a solder ball; providing a metal mold including a die plate which is independently provided to enable an approach/separation to/from the second wiring board; inserting the semiconductor device into a cavity of the metal mold; abutting the die plate on a surface side of the second wiring board through a release film; injecting a mold resin in a void between the first wiring board and the second wiring board while applying a first pressure from the die plate to the second wiring board; and further injecting the mold resin in the void while applying a second pressure which is higher than the first pressure from the die plate to the second wiring board. In the mold resin molding method, the first pressure is set to permit an interval between the first wiring board and the second wiring board to be enlarged by a pressure of the injected mold resin in the void, and the second pressure is set to forbid the interval from being additionally enlarged in order to prevent the solder ball from being disconnected.

Other aspects and advantages of the invention will be apparent from the following description, the drawings and the claims.

### BRIEF DESCRIPTION OF THE DRAWINGS

FIG. 1 is a schematic view for explaining an example of a metal mold to be used in the present invention;

FIG. 2 is a graph for explaining a pressure in a cavity of the metal mold illustrated in FIG. 1;

FIG. 3 is a schematic view for explaining another example of the metal mold to be used in the present invention;

FIG. 4 is a schematic view for explaining yet another example of the metal mold to be used in the present invention;

FIG. 5 is a schematic view for explaining a further example of the metal mold to be used in the present invention;

FIG. 6 is a sectional view showing a semiconductor device molded in accordance with the present invention;

FIG. 7 is a sectional view showing the semiconductor device to be molded in accordance with the present invention;

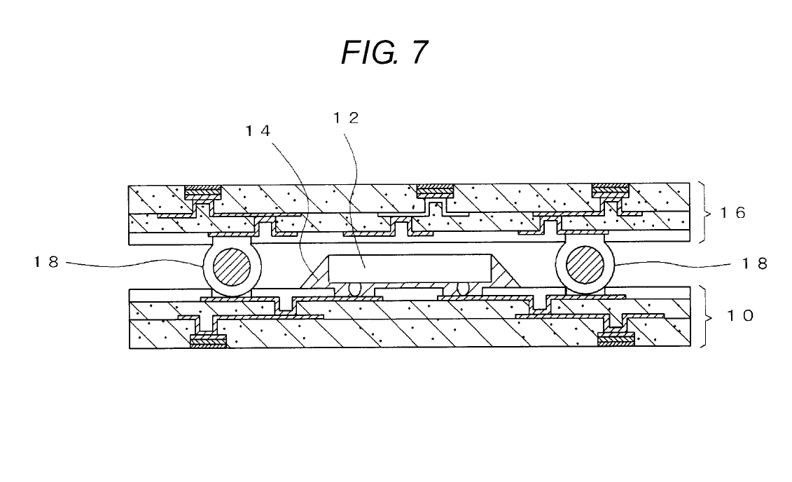

FIG. 8 is a schematic view for explaining a related-art metal mold; and

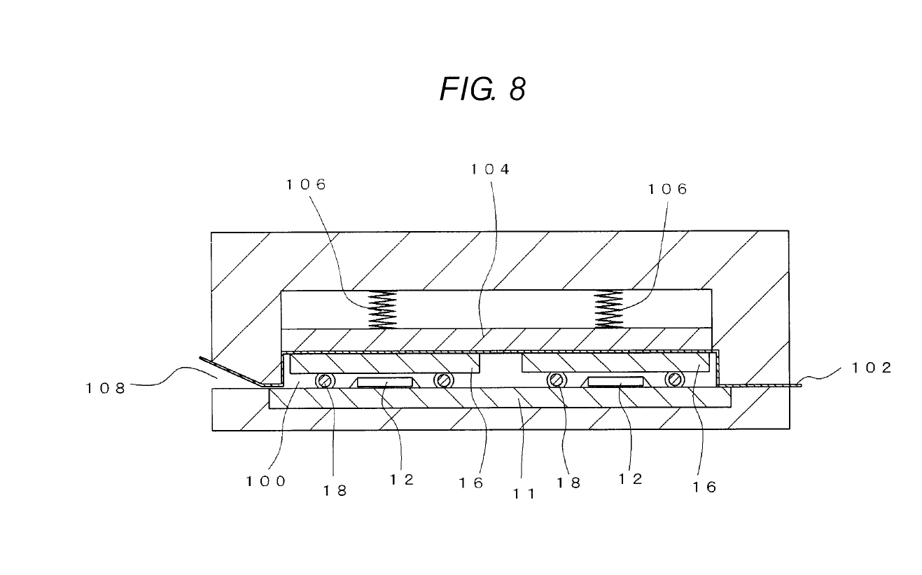

FIG. 9 is a sectional view for schematically explaining a related-art molded product obtained by carrying out molding through the metal mold illustrated in FIG. 8.

### DETAILED DESCRIPTION OF EXEMPLARY EMBODIMENTS

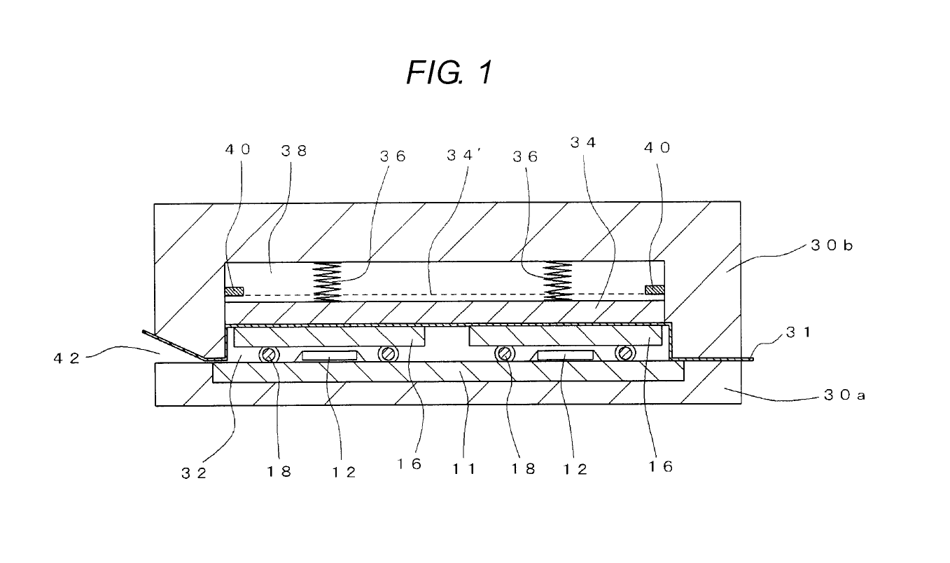

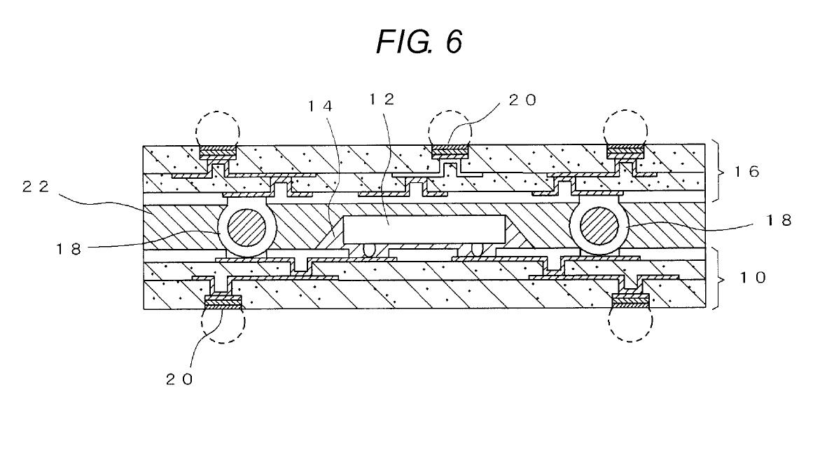

FIG. 1 shows an example of a metal mold to be used in the present invention. A substrate 11 inserted in a cavity 32 constituted by a lower mold 30a and an upper mold 30b in the metal mold shown in FIG. 1 is mounted on the lower mold 30a. A plurality of first wiring boards 10 shown in FIG. 6 are fabricated into the substrate 11. Semiconductor elements 12 are mounted on each of portions of the substrate 11 which correspond to the respective first wiring boards 10, and furthermore, second wiring boards 16 and 16 are electrically connected and laminated respectively through copper core solder balls 18 which have core portions made of copper. The solder ball 18 may be a resin core solder ball having a core portion made of a resin.

In the metal mold shown in FIG. 1, a mounting surface of the substrate 11 mounted on the lower mold 30a on which the semiconductor elements 12 and 12 are mounted forms a bottom face of the cavity 32. At a surface side of the second wiring boards 16 and 16 laminated on a predetermined place of the substrate 11, a die plate 34 to abut through a release film 31 is independently provided to enable an approach/separation to/from the second wiring boards 16 and 16 in a concave portion 38 formed on the upper mold 30b.

Furthermore, the die plate 34 is elastically pushed in a direction of the second wiring boards 16 and 16 by means of springs 36 and 36 in order to apply a predetermined pressure to the second wiring boards 16 and 16 during molding in the concave portion 38 of the upper mold 30b.

The springs 36 and 36 serve as first pressure applying means for applying a first pressure obtained by adding an own weight of the die plate 34 to each of the second wiring boards 16 and 16 through the release film 31.

The first pressure serves to prevent a mold resin injected from a gate 42 into the cavity 32 from entering a portion between the release film 31 and a surface of each of the second wiring boards 16 and 16, and is regulated into such a pressure as to permit an interval between the substrate 11 and each of the second wiring boards 16 and 16 to be enlarged by a pressure of the mold resin filled in a space between the substrate 11 and each of the second wiring boards 16 and 16. It is possible to regulate the first pressure by adjusting an elastic force of the springs 36 and 36.

Moreover, stoppers 40 and 40 for controlling an upper limit position of the die plate 34 are provided in the concave portion 38 of the upper mold 30b.

The stoppers 40 and 40 are placed in positions in which the interval between the substrate 11 and each of the second wiring boards 16 and 16 can be prevented from being enlarged in an abutment of the die plate 34 moved with the enlargement of the interval between the substrate 11 and each of the second wiring boards 16 and 16 by the pressure of the filled mold resin, and the solder balls 18 and 18 can be inhibited from being disconnected and a second pressure to be applied from the die plate 34 to the second wiring boards 16 and 16 can be set to be higher than the first pressure. Accordingly, the stoppers 40 and 40 serve as second pressure applying means.

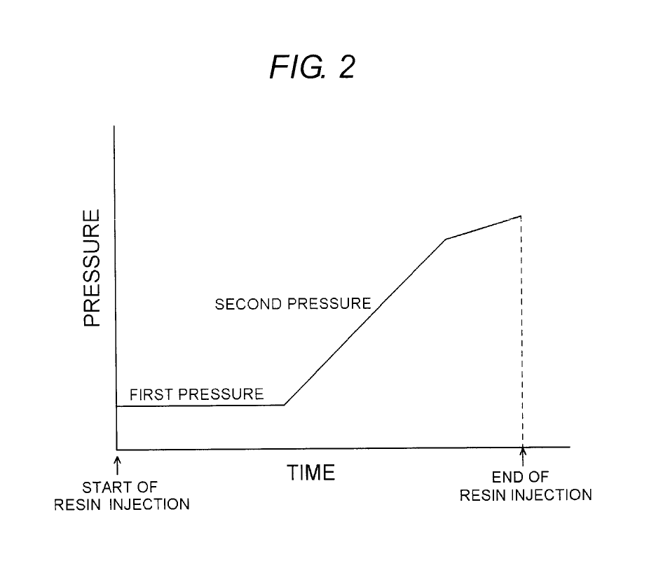

A mold resin which is molten in a pot (not shown) is injected from the gate 42 into the cavity 32 of the metal mold shown in FIG. 1 with a movement of a piston (not shown) at a predetermined speed and is filled in the space between the substrate 11 and each of the second wiring boards 16 and 16. FIG. 2 shows a change in a pressure in the cavity 32 at this time.

As shown in FIG. 2, at a start of the injection of the mold resin, a pressure of the mold resin which is applied to the second wiring boards 16 and 16 by the springs 36 and 36 and the die plate 34 is equal to the first pressure. Therefore, the mold resin injected into the cavity 32 does not enter the portion between the release film 31 and the surfaces of the second wiring boards 16 and 16 but is filled in the space between the substrate 11 and each of the second wiring boards 16 and 16.

In addition, the first pressure serves to permit an enlargement of the interval between the substrate 11 and each of the second wiring boards 16 and 16, that is, an enlargement of a capacity of the cavity 32 by the pressure of the mold resin filled in the space between the substrate 11 and each of the second wiring boards 16 and 16. Therefore, it is possible to fill the mold resin by enlarging the interval between the substrate 11 and each of the second wiring boards 16 and 16, particularly, a small gap between the semiconductor element 12 and the second wiring board 16. Consequently, the mold resin can be uniformly filled in the space between the substrate 11 and each of the second wiring boards 16 and 16.

When the mold resin is filled in the space between the substrate 11 and each of the second wiring boards 16 and 16 at the first pressure, thus, the interval between the substrate 11 and each of the second wiring boards 16 and 16 is enlarged by the pressure of the filled mold resin so that the die plate 34 is close to the stoppers 40 and 40.

When the die plate 34 reaches a position 34′ in which it abuts on the stoppers 40 and 40 as shown in FIG. 1, the movement of the die plate 34 is stopped. Consequently, the interval between the substrate 11 and each of the second wiring boards 16 and 16 is made constant. Therefore, the enlargement of the interval between the substrate 11 and each of the second wiring boards 16 and 16 is stopped so that the solder balls 18 and 18 can be prevented from being disconnected.

On the other hand, the movement of the die plate 34 is stopped so that the capacity of the cavity 32 is made constant. Therefore, the pressure of the mold resin in the cavity 32 is changed to be the second pressure which is higher than the first pressure as shown in FIG. 2.

In addition, the remainder of the mold resin which is molten in the pot (not shown) is injected from the gate 42 by means of the piston (not shown) to further raise the pressure in the cavity 32. By the rise in the pressure, bubbles in the mold resin filled in the space between the substrate 11 and each of the second wiring boards 16 and 16 are eliminated.

As means for eliminating the bubbles in the cavity 32, it is also possible to discharge the bubbles from an inner part of the cavity 32 by weighting and pushing down the die plate 34 (for example, pushing down the die plate 34 by 40 to 50 μm) after the injection of the mold resin to raise the pressure in the cavity 32, thereby holding the condition for a predetermined time (for example, for several seconds to several minutes).

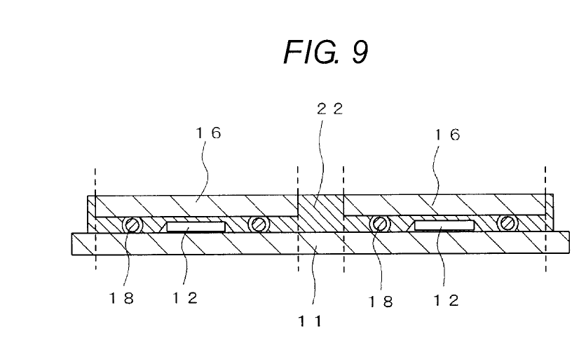

After the end of the operation for filling the mold resin into the cavity 32, the mold resin was cured. And then the lower mold 30a and the upper mold 30b are opened. Thus, it is possible to take the molded product shown in FIG. 9 out.

By cutting the molded product thus obtained in the position shown in the dotted line of FIG. 9, it is possible to acquire the semiconductor device illustrated in FIG. 6.

In the semiconductor device, the first wiring board 10 and the second wiring board 16 are electrically connected to each other through the solder balls 18 and 18, and the portion between the first wiring board 10 and the second wiring board 16 is uniformly filled with a mold resin 22.

Furthermore, a weld flash is prevented from being formed on the surfaces of the first wiring board 10 and the second wiring board 16 due to the entrance of the mold resin 22, and there is exposed each of pad surfaces of pads 20 and 20 to which an external connecting terminal is to be attached.

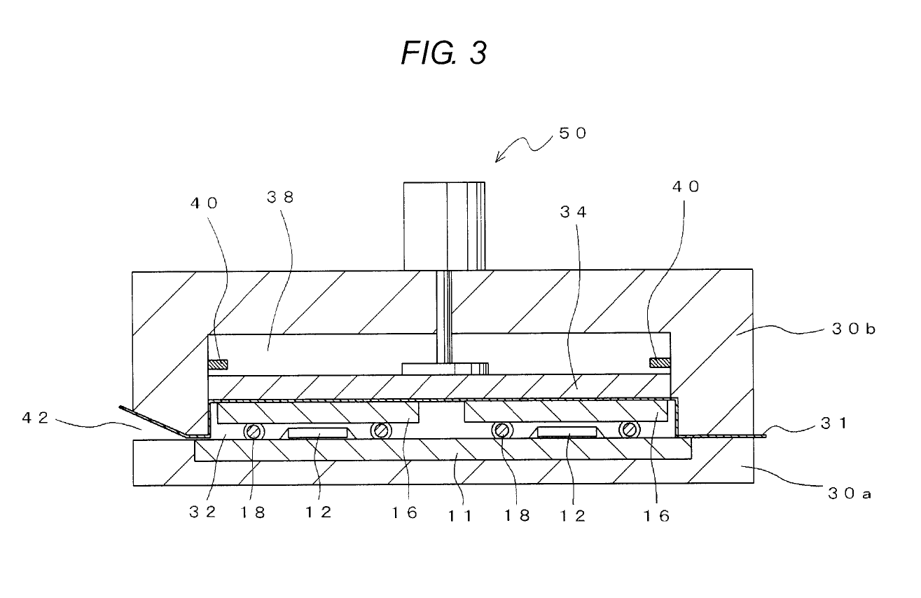

Although the springs 36 and 36 are used as the first pressure applying means in the metal mold shown in FIG. 1, it is also possible to use a cylinder device 50 as the first pressure applying means in place of the springs 36 and 36 as in a metal mold shown in FIG. 3.

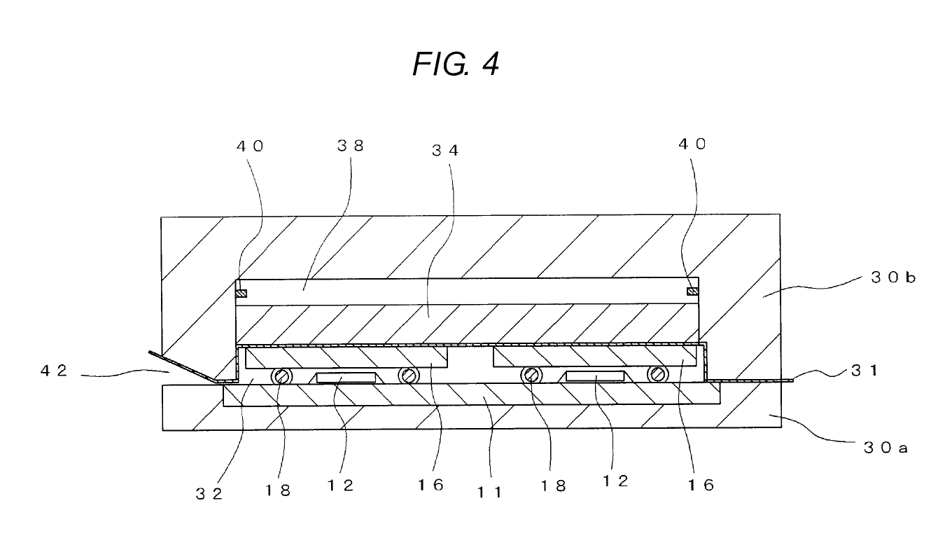

As in a metal mold shown in FIG. 4, moreover, the die plate 34 may be thickened to apply a predetermined first pressure to the second wiring boards 16 and 16 by an own weight of the die plate 34. In this case, the die plate 34 serves as the first pressure applying means.

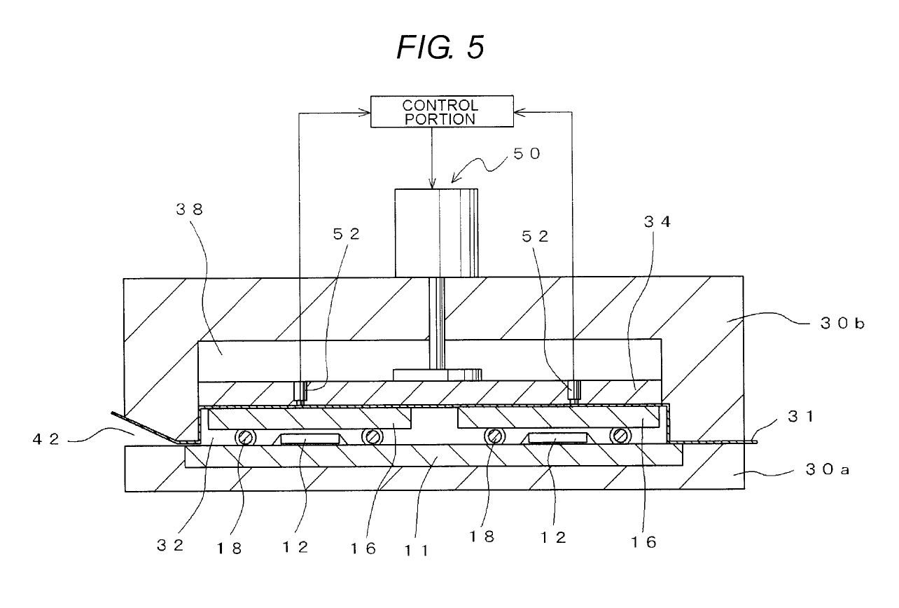

As in a metal mold shown in FIG. 5, the cylinder device 50 may be used as the first pressure applying means and the second pressure applying means. In the metal mold shown in FIG. 5, a pressure in the cavity 32 is controlled by the cylinder device 50.

In the metal mold shown in FIG. 5, a driving signal is transmitted from a control portion to the cylinder device 50 to control a position of the die plate 34 on the basis of a signal sent from pressure sensors 52 and 52 detecting a pressure to be applied to the second wiring boards 16 and 16 from the die plate 34. Depending on the position of the die plate 34, the pressure in the cavity 32 can be set to the first pressure or the second pressure shown in FIG. 2.

Although the semiconductor device having the second wiring boards 16 and 16 provided on the single substrate 11 into which the first wiring boards 10 and 10 are fabricated is used to carry out the molding in the metal molds shown in FIGS. 1 to 5, it is a matter of course that a semiconductor device divided into individual pieces constituted by the first wiring board 10 and the second wiring board 16 may be used to carry out the molding.

Referring to the semiconductor device to be used in the invention, the underfill agent is filled between the mounting surface of the first wiring board and the semiconductor element mounted on the mounting surface, and the second wiring board is electrically connected and laminated onto the mounting surface of the first wiring board through the solder ball. Therefore, a portion between the mounted semiconductor element and the second wiring board has a smaller gap than the interval between the first wiring board and the second wiring board.

A support member for holding the interval between both of the wiring boards, for example, the solder ball is not present in the vicinity of the portion on which the semiconductor element is mounted. When an external force toward the first wiring board side is applied to the second wiring board, accordingly, the second wiring board is easily warped toward the first wiring board side. Therefore, the small gap between the semiconductor element and the second wiring board is further reduced.

In the first wiring board, moreover, the void between the semiconductor element and the first wiring board is filled with the underfill agent. Therefore, the first wiring board is easily warped toward the second wiring board side due to a contraction of the underfill agent. Furthermore, the second wiring board is easily warped toward the first wiring board side through the solder ball. Therefore, the small gap between the semiconductor element and the second wiring board is reduced still more.

In this respect, in the invention, the predetermined first pressure for permitting the interval between the first wiring board and the second wiring board to be enlarged by the pressure of the injected mold resin is applied from the die plate to the second wiring board of the semiconductor device inserted into the cavity of the metal mold, and at the same time, the mold resin is injected in the cavity and is thus injected in the void between the first wiring board and the second wiring board in the semiconductor device.

Thus, the first pressure applied from the die plate to the second wiring board serves to enlarge the interval between the first wiring board and the second wiring board by the pressure of the filled mold resin. Therefore, the interval between the first wiring board and the second wiring board is enlarged by the pressure of the injected mold resin so that the mold resin can be quickly filled in the space between the first wiring board and the second wiring board.

In particular, the small gap between the semiconductor element mounted on the first wiring board and the second wiring board is also enlarged by the pressure of the injected/filled mold resin. Therefore, the mold resin can easily pass through the small gap so that an inner part of the space between the first wiring board and the second wiring board can be uniformly filled with the mold resin.

When the mold resin is continuously filled by the application of the first pressure to the second wiring board, there is a possibility that the interval between the first wiring board and the second wiring board might be enlarged by the pressure of the injected/filled mold resin, resulting in a disconnection of the solder ball.

In the invention, therefore, the second pressure which is higher than the first pressure is applied from the die plate to the second wiring board. Consequently, the interval between the first wiring board and the second wiring board is forbidden from being additionally enlarged by the pressure of the filled mold resin, and the solder ball is prevented from being disconnected, and at the same time, the mold resin is continuously filled.

In the invention, thus, the pressure to be applied to the second wiring board is varied to fill the mold resin in the space between the first wiring board and the second wiring board. Therefore, it is possible to uniformly fill the mold resin in the space between the first wiring board and the second wiring board while ensuring the connection of the solder ball.

While the present inventive concept has been shown and described with reference to certain exemplary embodiments thereof, it will be understood by those skilled in the art that various changes in form and details may be made therein without departing from the spirit and scope of the invention as defined by the appended claims.

What is claimed is:

1. A mold resin molding method comprising:
providing a semiconductor device including a first wiring board and a second wiring board electrically connected to the first wiring board through a solder ball;
providing a metal mold including a die plate which is independently provided to enable an approach/separation to/from the second wiring board;
inserting the semiconductor device into a cavity of the metal mold;
abutting the die plate on a surface side of the second wiring board through a release film;
injecting a mold resin in a void between the first wiring board and the second wiring board while applying a first pressure from the die plate to the second wiring board; and
further injecting the mold resin in the void while applying a second pressure which is higher than the first pressure from the die plate to the second wiring board,
wherein the first pressure is set to permit an interval between the first wiring board and the second wiring board to be enlarged by a pressure of the injected mold resin in the void, and the second pressure is set to forbid the interval from being additionally enlarged in order to prevent the solder ball from being disconnected.

2. The mold resin molding method according to claim 1, further comprising:
moving the die plate closer to a stopper by enlarging the interval between the first wiring board and the second wiring board when the mold resin is filled in the void between the first wiring board and the second wiring board while applying the first pressure from the die plate to the second wiring board; and
applying the second pressure which is higher than the first pressure from the die plate to the second wiring board after the die plate abuts on the stopper.

3. The mold resin molding method according to claim 1, wherein a semiconductor element is mounted on a mounting surface of the first wiring board, an underfill agent is filled between the semiconductor element and the mounting surface, and the second wiring board is electrically connected and laminated onto the mounting surface through the solder ball.

4. The mold resin molding method according to claim 3, wherein a copper core solder ball is used as the solder ball.

5. A mold resin molding apparatus comprising:
a metal mold which inserts, into a cavity of the metal mold, a semiconductor device including a first wiring board and a second wiring board electrically connected to the first wiring board through a solder ball, and for injecting a mold resin in a void between the first wiring board and the second wiring board, wherein
the metal mold includes:
a die plate which abuts on a surface side of the second wiring board through a release film and is provided independently to enable an approach/separation to/from the second wiring board;
a first pressure applying unit which applies a first pressure from the die plate to the second wiring board; and
a second pressure applying unit which applies a second pressure which is higher than the first pressure from the die plate to the second wiring board, and wherein
the first pressure is set to permit an interval between the first wiring board and the second wiring board to be enlarged by a pressure of the injected mold resin in the void, and the second pressure is set to forbid the interval from being additionally enlarged in order to prevent the solder ball from being disconnected.

6. The mold resin molding apparatus according to claim 5, wherein the first pressure applying unit is a spring which pushes the die plate and allows the die plate to apply the first pressure to the second wiring board.

7. The mold resin molding apparatus according to claim 5, wherein the second pressure applying unit is a stopper which applies the second pressure from the die plate to the second wiring board by abutting the die plate with the enlargement of the interval between the first wiring board and the second wiring board when injecting the mold resin in the void.

8. The mold resin molding apparatus according to claim 5, wherein a semiconductor element is mounted on a mounting surface of the first wiring board, an underfill agent is filled between the semiconductor element and the mounting surface, and the second wiring board is electrically connected and laminated onto the mounting surface through the solder ball.

9. The mold resin molding apparatus according to claim 8, wherein a copper core solder ball is used as the solder ball.
